(19) United States
(12) Patent Application Publication
(10) Pub. No.: US 2008/0183360 A1
(43) Pub. Date: Jul. 31, 2008

(54) Vehicle collision avoidance and warning

(76) Inventors: Yizhen Zhang, Sunnyvale, CA (US); Erik K. Antonsson, Pasadena, CA (US)

Correspondence Address: SETH Z. KALSON;c/o INTOLLEVATE, P.O. BOX 52050, MINNEAPOLIS, MN, 55402, US

(21) Appl. No.: 11/800,962

(22) Filed: May 7, 2007

Related U.S. Application Data
(60) Provisional application No. 60/798,516, filed on May 8, 2006.
(60) Provisional application No. 60/817,117, filed on Jun. 28, 2006.

(51) Int. Cl. G06F 17/11; B60W 30/08; B60Q 1/00

(52) U.S. Cl. 701/70; 701/301; 340/436

(57) ABSTRACT

A vehicle warning system to provide a time-based measure, termed the time-to-last-second-braking time, which is a time buffer that is left for the driver, or control system, to react in order to achieve a desired minimum distance buffer during a collision avoidance process. This measure is based upon a velocity of the host vehicle, an acceleration of the host vehicle, a distance to a lead vehicle, a time rate of change of the distance to the lead vehicle, a relative acceleration between the host and lead vehicles, an acceleration of the host vehicle under maximum braking, and the minimum distance buffer. Various levels of warning may be provided, based upon the value of the time-to-last-second-braking time. Other embodiments are described and claimed.

### BENEFIT OF PROVISIONAL APPLICATION

This application claims the benefit of U.S. Provisional Application No. 60/798,516, filed 8 May 2006; and U.S. Provisional Application No. 60/817/117, filed 28 June 2006.

### FIELD

The present invention relates to automotive safety technology, and more particularly, to collision avoidance systems.

### BACKGROUND

Collision avoidance systems are an emerging automotive safety technology that may assist drivers in avoiding potential collisions. In a collision avoidance system, when a potential collision threat is identified by the system, appropriate warnings are issued to the driver to facilitate collision avoidance. Furthermore, if the driver fails to react in time to the warnings, an override system may take over control to avoid, or mitigate, the collision in an emergency situation, such as, for example, immediately applying maximum braking.

### BRIEF DESCRIPTION OF THE DRAWINGS

FIG. 1 illustrates a host vehicle and a lead vehicle according to an embodiment of the present invention.

FIG. 2 illustrates a flow diagram according to an embodiment of the present invention.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

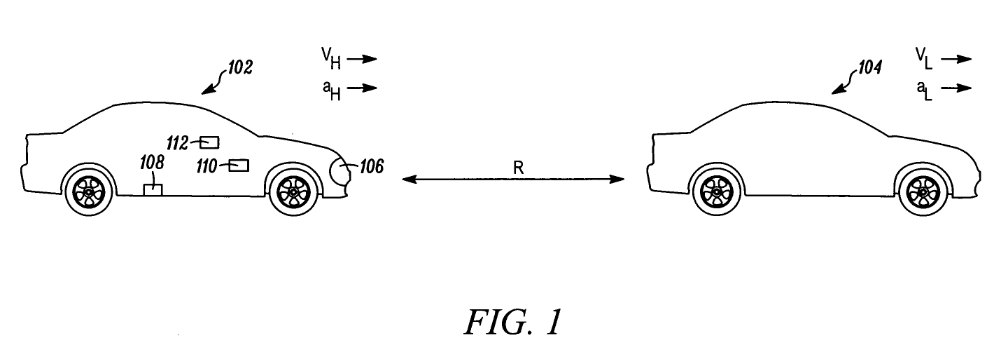

FIG. 1 illustrates, in simplified fashion, a vehicle according to an embodiment of the present invention, and serves to introduce various terms. Vehicle 102 will be referred to as the host vehicle, and vehicle 104 will be referred to as the lead vehicle. To put FIG. 1 into a practical context, the lead and host vehicles may be moving in the same direction along a road or highway, but the lead vehicle may without warning abruptly slow down, or come to a stop, due to, for example, heavy traffic, an accident, or some such event. The host vehicle is the vehicle of “interest” in the sense that it employs a collision avoidance and warning system according to an embodiment of the present invention, where the motivation for including such a system in the host vehicle is to help reduce the probability of a collision.

Sensor 106 in the host vehicle measures the range (or distance) R between the host vehicle and the lead vehicle. As an example, sensor 106 may comprise a LIDAR device to detect the lead vehicle and to measure its range from the host vehicle. Such a sensor may be placed, for example, near the front end of the host vehicle. Sensor 106 may also include a Doppler LIDAR to measure the time rate of change (time derivative) of the range, denoted as R. Some embodiments, however, may estimate R by measuring the range over successive times and estimating the derivative of the range with respect to time. LIDAR devices may be utilized in other parts of the host vehicle, but for simplicity, only one is illustrated near the front end of the host vehicle. Other ranging sensors, such as acoustic sensors, may be included in the host vehicle.

The host vehicle may include other sensors to measure other parameters external to the host vehicle. For example, sensor 108 may comprise a tire-road friction coefficient monitor. Such information may be used to help estimate the maximum deceleration of the host vehicle under maximum braking. Additional sensors may be incorporated throughout the host vehicle to measure other parameters associated with the host vehicle itself, such as total weight, the condition of the brakes, tire pressure, tire tread depth, etc., which may help in estimating the maximum deceleration.

Processor system 110 provides control to the various sensors, and processes signals received by the sensors. In practice, processor system 110 may comprise one or more processors, which may reside in one location of the host vehicle, or may be distributed throughout the host vehicle. Some or all components of processor system 110 may also be used for other functions, such as monitoring engine performance, etc., which may not be related to collision avoidance and warning.

The host vehicle also includes one or more warning indicators, collectively represented by functional unit 112. Under various conditions, processor system 110 may cause one or more of these indicators to warn the driver of the host vehicle of a dangerous situation calling for attention. A warning indicator may be an auditory or visual indicator. For example, a visual indicator may be a dashboard light, or as another example, a heads-up display in which a visual warning is projected onto and reflected off of the windshield. Processor system 112 may also include an override functional unit, whereby control of various functions, such as for example braking, are taken away from the driver so as to provide quick action to help avoid a collision.

Other measured quantities are noted in FIG. 1. The measured velocity and acceleration for the host vehicle are denoted, respectively, by ν_{H} and α_{H}; and the measured velocity and acceleration for the lead vehicle are denoted, respectively, by ν_{L} and α_{L}. For simplicity, FIG. 1 may be considered one-dimensional, so that velocity and acceleration are scalars. The algebraic sign convention may be taken so that the positive x-axis points toward the right hand side of FIG. 1. Accordingly, velocity is positive when the vehicles are moving toward the right hand side of FIG. 1, and acceleration is positive when the vehicles are speeding up toward the right hand side. When describing the embodiments, it is convenient to consider the particular case in which the velocities of the host and lead vehicles are both positive, and the accelerations of the host and lead vehicles are both negative. However, embodiments are not limited to such a choice. Often, when an object has a negative acceleration, it is commonly referred to as decelerating. However, it is convenient to refer to the variables α_{H} and α_{L} as accelerations, keeping in mind that an acceleration variable may be a positive or negative scalar.

Embodiments of the present invention make use of a time-based measure, termed the time-to-last-second-braking time, denoted by T_{LSB}. This measure is the time remaining for the driver, or control system, at the current situation (state) to take the last extreme evasive action, e.g., braking at the maximum level, to avoid a rear-end collision with the lead vehicle. This measure calculates how much time buffer is left for the driver, or control system, to react in order to achieve a desired minimum distance buffer during the collision avoidance process, which may be denoted as Rₘᵢₙ. In a sense, this measure gives a quantitative assessment of the current urgency and severity levels of the potential threats in terms of time, which is expected to be highly useful for threat assessment analysis for collision warning and avoidance systems.

Embodiments estimate T_{LSB} by using the following six variables: ν_{H}, α_{H}, R, \dot{R}, α_{R}, and α_{Hmax}; where α_{R}≡α_{L}−α_{H} is the relative acceleration; and α_{Hmax} is the acceleration of the host vehicle during maximum braking. The functional dependence of T_{LSB} upon these variables may be written as

T_{LSB}=ƒ(ν_{H}, α_{H}, R, \dot{R}, α_{R}, α_{Hmax}),

where for some embodiments, ν_{H} and α_{H} may be measured by vehicle state sensors, R and \dot{R} may be measured or estimated by on-board radar or LIDAR sensors (\dot{R} may be estimated from the time history of R), α_{R} may be estimated from the \dot{R} history, and α_{Hmax} may be estimated from a tire-road friction coefficient monitor.

T_{LSB} is calculated based on the assumptions that if the lead vehicle is decelerating, it will continue to do so uniformly at the current α_{L} until it comes to a full stop; and that the host vehicle also will maintain the current α_{H} until that last moment for which it will be able to decelerate at its maximum deceleration level, denoted as α_{Hmax}, to avoid the collision. Therefore, T_{LSB} estimates the length of time for which the host vehicle may maintain its current state until it should brake at the maximum level to just avoid a rear-end collision with the lead vehicle.

Two different cases are considered in estimating T_{LSB}, depending on whether the lead vehicle is estimated to stop first or not, that is, whether the lead vehicle stopping time, denoted by t_{LS}, is greater than or less than the host vehicle stopping time, denoted by t_{HS}. The lead vehicle stopping time may be expressed as

$${t}_{LS} = \frac{- {v}_{L}}{{a}_{L}} = \frac{- ( {v}_{H} + \dot{R} )}{{a}_{R} + {a}_{H}} . \qquad ( 1 )$$

The host vehicle stopping time may be expressed as

$${t}_{HS} = {T}_{LSB} - \frac{{v}_{H} + {a}_{H} {T}_{LSB}}{{a}_{H max}} . \qquad ( 2 )$$

In the above expression for t_{HS}, it may be assumed that ν_{H}+α_{H}T_{LSB}>0, for otherwise, the host vehicle would already be decelerating sufficiently hard enough so that no further action need be taken.

Under the above assumptions, the variables are related by the following set of relationships

$$R = \{ \begin{matrix}{v}_{H} {T}_{LSB} + \frac{{a}_{H}}{2} {T}_{LSB}^{2} - \frac{{( {v}_{H} + {a}_{H} {T}_{LSB} )}^{2}}{2 {a}_{H max}} + \frac{{v}_{L}^{2}}{2 {a}_{L}} + {R}_{min} & {t}_{LS} \leq {t}_{HS} \\ - \dot{R} {T}_{LSB} - \frac{1}{2} {a}_{R} {T}_{LSB}^{2} + \frac{{( \dot{R} + {a}_{R} {T}_{LSB} )}^{2}}{2 ( {a}_{L} - {a}_{H max} )} + {R}_{min} & {t}_{LS} > {t}_{HS}\end{matrix} \qquad \begin{matrix}( 3 a ) \\ ( 3 b )\end{matrix}$$

where the minimum distance buffer Rₘᵢₙ may vary from embodiment to embodiment. As one example, Rₘᵢₙ may be taken as 5 meters. Note that the conditions for Eqs. (3a) and (3b) may instead be t_{LS}<t_{HS} and t_{LS}≧t_{HS}, respectively. Other embodiments may employ a different set of assumptions, leading to a different set of relationships.

Various techniques may be used to solve for T_{LSB}. An approach for some embodiments is to first assume that the lead vehicle stops first (t_{LS}≦t_{HS}), then T_{LSB} can be solved from Eq. (3a). Then, t_{LS} and t_{HS} can be found from Eqs. (1) and (2), respectively, to verify if the assumption that t_{LS}≦t_{HS} holds. If, however, this assumption doesn't hold, then Eq. (3b) is used to estimate T_{LSB}.

Depending on the estimated value for T_{LSB}, embodiments may provide various warning signals to the driver, and embodiments may provide an override system at critical moments to automatically apply braking at the maximum level to avoid collisions. For example, embodiments may provide a first level of warnings if the measure T_{LSB} falls within a first time interval, and a second level of warnings if T_{LSB} falls within a second time interval. Embodiments may also override the driver to provide automatic braking if T_{LSB} is less than some threshold.

The second level of warnings is meant to convey a greater sense of urgency than the first level of warnings. The first level of warnings may be described as cautionary warnings, and the second level of warnings may be described as imminent warnings. An example of a cautionary warning is a visual signal, whereas an example of an imminent warning is a visual signal in conjunction with an auditory signal. Some embodiments may employ more than two levels of warnings. Some embodiments may employ a near-continuous range of warnings, or some combination of a finite number of warning levels and a near-continuous range of warnings. For example, the volume of the auditory warning may increase as the numerical value of the measure T_{LSB} decreases.

As an example of a particular embodiment, a cautionary warning, such as a visual signal, may be issued if 1.5 s≦T_{LSB}<2.5 s; an imminent warning, such as a visual signal in conjunction with an auditory signal, may be issued if 0.5 s≦T_{LSB}<1.5 s; and an override system may be activated if T_{LSB}<0.5 s.

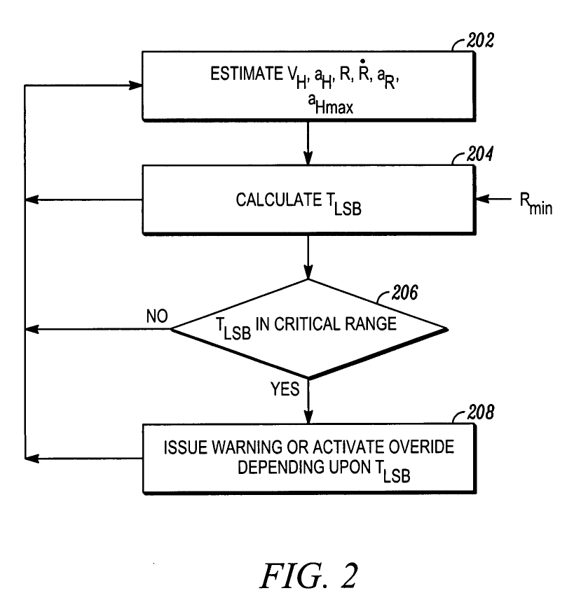

The flow diagram of FIG. 2 illustrates the above description at a high level. The blocks indicated in FIG. 2 represent functional units by which processor system 110 processes signals provided by various sensors in the host vehicle. A functional unit may represent special purpose hardware, software, firmware, or some combination thereof. A functional unit may be referred to as a module. For a software or firmware module, processor system 110 may be considered to include media for storing the instructions implementing the software or firmware module.

In module 202, the six variables ν_{H}, α_{H}, R, \dot{R}, α_{R}, and α_{Hmax} are estimated. It is to be understood that estimating a variable may also refer to the situation in which the variable is provided directly from a sensor and its associated circuits so that an actual estimation need not be performed. In module 204, T_{LSB} is calculated based upon the six variables, as well as a value chosen for the desired minimum distance buffer Rₘᵢₙ. If module 206 determines that T_{LSB} falls within a critical range, then depending upon the value of T_{LSB}, various warnings may be given, or an override system may be activated, as indicated in module 208 and discussed earlier.

Various modifications may be made to the described embodiments without departing from the scope of the invention as claimed below.

Throughout the description of the embodiments, various mathematical relationships are used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as “designed for” relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

What is claimed is:

1. A system comprising:
a processor system to provide a time-to-last-second-braking measure; and
a warning system coupled to the processor system to provide a first level warning if the time-to-last-second-braking measure is within a first interval.

2. The system as set forth in claim 1, wherein the first level warning is a visual warning.

3. The system as set forth in claim 1, the warning system to further provide a second level warning if the time-to-last-second-braking measure is within a second interval.

4. The system as set forth in claim 3, wherein the first level warning is a visual warning and the second level warning comprises an auditory warning.

5. The system as set forth in claim 1, further comprising:
an override system to provide automatic braking if the time-to-last-second-braking measure is within a third interval.

6. The system as set forth in claim 5, wherein the third interval is the set of real numbers less than a threshold.

7. The system as set forth in claim 1, the processor system to calculate the time-to-last-second-braking measure based upon a velocity of a host vehicle, an acceleration of the host vehicle, a distance to a lead vehicle, a time rate of change of the distance to the lead vehicle, a relative acceleration between the host and lead vehicles, an acceleration of the host vehicle under maximum braking, and a minimum distance buffer.

8. The system as set forth in claim 7, wherein the processor system calculates the time-to-last-second-braking, denoted as T_{LSB}, to satisfy the relationship
$$R = \{ \begin{matrix}{v}_{H} {T}_{LSB} + \frac{{a}_{H}}{2} {T}_{LSB}^{2} - \frac{{( {v}_{H} + {a}_{H} {T}_{LSB} )}^{2}}{2 {a}_{H max}} + \frac{{v}_{L}^{2}}{2 {a}_{L}} + {R}_{min} & {t}_{LS} \leq {t}_{HS} \\ - \dot{R} {T}_{LSB} - \frac{1}{2} {a}_{R} {T}_{LSB}^{2} + \frac{{( \dot{R} + {a}_{R} {T}_{LSB} )}^{2}}{2 ( {a}_{L} - {a}_{H max} )} + {R}_{min} & {t}_{LS} > {t}_{HS}\end{matrix}$$
where ν_{H} denotes the velocity of the host vehicle, α_{H} denotes the acceleration of the host vehicle, R denotes the distance to the lead vehicle, \dot{R} denotes the time rate of change of the distance to the lead vehicle, α_{R} denotes the relative acceleration between the host and lead vehicles, α_{Hmax} denotes the acceleration of the host vehicle under maximum braking, and Rₘᵢₙ denotes the minimum distance buffer; and where
$${t}_{LS} = \frac{- ( {v}_{H} + \dot{R} )}{{a}_{R} + {a}_{H}} , \\ and$$
$${t}_{HS} = {T}_{LSB} - \frac{{v}_{H} + {a}_{H} {T}_{LSB}}{{a}_{H max}} .$$

9. A method comprising:
estimating a velocity of a host vehicle, ν_{H}; an acceleration of the host vehicle, α_{H}; a distance to a lead vehicle, R; a time rate of change of the distance to the lead vehicle, \dot{R}; a relative acceleration between the host and lead vehicles, α_{R}; an acceleration of the host vehicle under maximum braking, α_{Hmax}; and a minimum distance buffer, Rₘᵢₙ; and
estimating a time-to-last-second-braking measure, T_{LSB}, based upon the estimated variables ν_{H}, α_{H}, R, \dot{R}, α_{R}, α_{Hmax}, and Rₘᵢₙ.

10. The method as set forth in claim 9, wherein T_{LSB} satisfies the relationship
$$R = \{ \begin{matrix}{v}_{H} {T}_{LSB} + \frac{{a}_{H}}{2} {T}_{LSB}^{2} - \frac{{( {v}_{H} + {a}_{H} {T}_{LSB} )}^{2}}{2 {a}_{H max}} + \frac{{v}_{L}^{2}}{2 {a}_{L}} + {R}_{min} & {t}_{LS} \leq {t}_{HS} \\ - \dot{R} {T}_{LSB} - \frac{1}{2} {a}_{R} {T}_{LSB}^{2} + \frac{{( \dot{R} + {a}_{R} {T}_{LSB} )}^{2}}{2 ( {a}_{L} - {a}_{H max} )} + {R}_{min} & {t}_{LS} > {t}_{HS}\end{matrix} \\ where \\ {t}_{LS} = \frac{- ( {v}_{H} + \dot{R} )}{{a}_{R} + {a}_{H}} , \\ and \\ {t}_{HS} = {T}_{LSB} - \frac{{v}_{H} + {a}_{H} {T}_{LSB}}{{a}_{H max}} .$$

11. The method as set forth in claim 9, further comprising:
providing a first level of warning if T_{LSB} is within a first interval.

12. The method as set forth in claim 11, wherein the first level of warning is a visual signal.

13. The method as set forth in claim 11, further comprising:
providing a second level of warning if T_{LSB} is within a second interval.

14. The method as set forth in claim 13, wherein the first level of warning is a visual signal, and the second level of warning comprises a visual warning and an audio warning.

15. An article of manufacture comprising media to store instructions, the instructions to cause a processor system to calculate a time-to-last-second-braking, denoted as T_{LSB}, such that T_{LSB} satisfies the relationship
$$R = \{ \begin{matrix}{v}_{H} {T}_{LSB} + \frac{{a}_{H}}{2} {T}_{LSB}^{2} - \frac{{( {v}_{H} + {a}_{H} {T}_{LSB} )}^{2}}{2 {a}_{H max}} + \frac{{v}_{L}^{2}}{2 {a}_{L}} + {R}_{min} & {t}_{LS} \leq {t}_{HS} \\ - \dot{R} {T}_{LSB} - \frac{1}{2} {a}_{R} {T}_{LSB}^{2} + \frac{{( \dot{R} + {a}_{R} {T}_{LSB} )}^{2}}{2 ( {a}_{L} - {a}_{H max} )} + {R}_{min} & {t}_{LS} > {t}_{HS}\end{matrix}$$
where ν_{H} denotes a first velocity, α_{H} denotes an acceleration, R denotes a distance, \dot{R} denotes the time rate of change of the distance, α_{R} denotes a relative acceleration, α_{Hmax} denotes an acceleration under maximum braking, and Rₘᵢₙ denotes a minimum distance buffer; and where
$${t}_{LS} = \frac{- ( {v}_{H} + \dot{R} )}{{a}_{R} + {a}_{H}} , \\ and$$
$${t}_{HS} = {T}_{LSB} - \frac{{v}_{H} + {a}_{H} {T}_{LSB}}{{a}_{H max}} .$$
